(19) United States
(12) Patent Application Publication
(10) Pub. No.: US 2025/0075917 A1
(43) Pub. Date: Mar. 6, 2025

(54) DOORS FOR HOME APPLIANCE AND HOME APPLIANCE INCLUDING THE SAME

(71) Applicant: LG ELECTRONICS INC., Seoul (KR)

(72) Inventor: DongWoo Kim, Seoul (KR)

(21) Appl. No.: 18/817,437

(22) Filed: Aug. 28, 2024

(30) Foreign Application Priority Data
Aug. 29, 2023 (KR) 10-2023-0113778

(51) Int. Cl. F24C 15/02

(52) U.S. Cl. CPC F24C 15/022; F24C 15/023

(57) ABSTRACT

A door of a home appliance includes a door body disposed in front of a storage space of the home appliance, and in which an electronic component is disposed. A connector module is disposed in the door body. The connector module includes a mounting base disposed in the door body, and a movement supporter moved along a seating surface of the mounting base. A door connector is disposed at the movement supporter and moved along with the movement supporter. At least one storage fixation portion is provided on the seating surface or a facing surface of the movement supporter facing the seating surface. The at least one storage fixation portion restricts movement of the movement supporter.

### CROSS REFERENCE TO RELATED APPLICATIONS

The present application claims priority to and the benefit of Korean Patent Application No. 10-2023-0113778, filed on Aug. 29, 2023, the disclosure of which is incorporated herein by reference in its entirety.

### TECHNICAL FIELD

The present disclosure relates to a door for a home appliance.

### BACKGROUND

Home appliances may store target objects and include doors. For example, home appliances include a cooking appliance, a refrigerator, a clothing treating apparatus, etc. The home appliances may include storage spaces for storing target objects in cabinets, creating the external appearance thereof, and doors to open and close the storage spaces.

Various electronic components may be installed in the door of the home appliance. For example, a touch sensor device, a display device, etc. may be installed in the door.

The electronic components may be electrically connected to a main controller provided in a main body of the home appliance with one or more wires.

To facilitate the connection of the wire, the wire may be connected to a connector. For example, a door connector protruding from the door and a main body connector protruding from the main body of the home appliance may be assembled with each other. As described above, the door connector and the main body connector (which is also referred to as “connector assembly” in this disclosure) are disposed not to be exposed outward. For example, the connector assembly is stored in a frame of the main body close to the door and a storage entrance may be covered with a separate cover.

For instance, assembling of the connector assembly may be performed after the door is assembled to the main body. After the door is assembled to the main body, the door connector may be assembled to the main body connector. However, a narrow gap between the door and the main body may make the assembly of the connectors difficult.

Furthermore, to reduce exposure of the wire and the connector assembly, the connector assembly and the wire may be disposed at a lower portion of the main body. In this case, the assembly operation of the connector assembly may be performed at lower portions of the main body and the door. Accordingly, an operator (e.g., assembler) must put together the connector assembly without accurately checking the connector assembly with the naked eye, which requires skill in the assembly operation of the connector assembly and reduces the workability.

Specifically, a connector has directionality, and the operator must perform the assembly operation in the narrow space between the main body and the door while checking the direction of the connector assembly, which further reduces workability.

In some examples, regarding the home appliance, products such as cooking appliance that create high-temperature environments in a storage space cause the main bodies to be heated to high temperatures. As described above, the high temperature of the main body affects the connector assembly, reducing durability of the connector assembly and resulting in damage to the connector assembly.

In addition, due to the narrow inner space of the frame of the main body adjacent to the door, maintenance of the connector assembly is difficult. Specifically, to insert the connector assembly into the frame, or to remove the connector assembly inside the frame outward, the operator must access the connector assembly through the narrow inner space of the frame, which reduces workability. Furthermore, when the operator inserts the connector assembly deep inside the frame, it may be difficult to remove the connector assembly.

In some examples, the conventional connector assembly may not be guided along a specific path and may be installed to move freely when pulled by the connected wire. Accordingly, in such cases, the operator must precisely grip and fix the two connectors with both hands before assembling the connectors. However, as described above, when the two connectors are assembled in a narrow space, it may be difficult to grip and assemble the connectors, which may be a disadvantage.

In addition, a wire installed in the main body of the home appliance and a wire installed in the door may be fixed by separate fasteners at regular intervals for assembly stability. As described above, the connectors provided at terminal ends of the wires fixed by the fasteners are limited in terms of movable distances and directions. When the wires are sufficiently long, the operational distance for coupling the connectors increases, which improves workability. However, long exposed sections of wires that extend outward deteriorate the aesthetics and reduces the durability, as the sheath may be damaged due to friction with the external part. On the other hand, when the wires are shortened, the sections where the wires are exposed outward are shortened, improving the aesthetics and reducing friction with the external part. However, there creates some issues as the workability of assembling the two connectors is reduced.

### SUMMARY

The present disclosure describes assembling of a wire and a connector connected to an electronic component disposed in a door with a relative connector (main body connector) and storing the assembly in the door.

The present disclosure further describes moving a connector stored in a door between a storage position and an operation position along a constant path.

The present disclosure further describes exposing a connector moved to an operation position outward.

The present disclosure further describes aligning a connector in a constant direction when the connector is moved to an operation position.

The present disclosure further describes adjusting the storage depth of a connector in a door to respond to a variety of extra lengths of a wire.

Aspects of the present disclosure are not limited to the above-described ones. Additionally, other aspects and advantages that have not been mentioned can be clearly understood from the following description and can be more clearly understood from implementations. Further, it will be understood that the aspects and advantages of the present disclosure can be realized via means and combinations thereof that are described in the appended claims.

According to the features of the present disclosure to achieve the above-described objectives, each of doors for a home appliance of the present disclosure may include a door body disposed in front of a storage space of the home appliance and in which an electronic component is disposed. A connector module may be disposed in the door body. The connector module may include a mounting base disposed in the door body, and a movement supporter moved along a seating surface of the mounting base. A door connector may be disposed at the movement supporter and moved along with the movement supporter. At this point, a storage fixation portion may be provided on the seating surface and a surface of the movement supporter facing the seating surface. The storage fixation portion may restrict movement of the movement supporter.

In addition, the storage fixation portion may include a first position fixation part provided at the seating surface, and a second position fixation part provided at the surface of the movement supporter. The second position fixation part may be engaged with the first position fixation part.

Furthermore, the first position fixation part may have an uneven structure sequentially disposed along a movement direction of the movement supporter, and the second position fixation part may be caught and fixed by the first position fixation part due to elastic deformation.

In addition, the second position fixation part may include a connection bridge connected to the movement supporter, and a holding hook and a release lever provided at both ends of the connection bridge. The holding hook may be provided at a first end portion of the connection bridge. The holding hook may be engaged with the first position fixation part. The release lever may be provided at a second end portion of the connection bridge. The release lever may be elastically deformed toward the seating surface.

The holding hook and the release lever may be raised and lowered in opposing directions to each other with the connection bridge as a center point.

Furthermore, the movement supporter may be moved between a storage position and an operation position along the seating surface, and the first position fixation part may have an inclined structure in which a height is gradually lowered in a direction toward the operation position.

In addition, the first position fixation part may include a plurality of sawtooth parts. Each sawtooth part may include a vertical surface standing in a direction in which the movement supporter is stacked on the seating surface, and an inclined surface of which a height is gradually lowered in a movement direction of the movement supporter.

Furthermore, the second position fixation part may include a relative vertical surface caught by the vertical surface in surface-contact with the vertical surface, and a relative inclined surface guided by the inclined surface by corresponding to the inclined surface.

In addition, a support guide groove may be recessed on the seating surface, and the first position fixation part may be provided at the support guide groove.

Furthermore, the movement supporter may include a guide block disposed in the support guide groove.

In addition, a first end portion of the support guide groove may be open toward the storage position. A mounting stopper may stand at a second end portion of the support guide groove. The movement supporter may interfere with the mounting stopper in a movement process.

Furthermore, a guide fence may stand at either side of the mounting base, and a guide step may protrude on the guide fence in a direction different from a standing direction of the guide fence. A part of the movement supporter may be disposed between the guide step and the seating surface.

In addition, the guide fence may include an assembly piece, and the assembly piece may be elastically deformed in a direction away from a center portion of the seating surface. The movement supporter may interfere with the assembly piece when being seated on the seating surface, and elastically deform the assembly piece.

An assembly protrusion may protrude from the assembly piece. The assembly protrusion may elastically deform the assembly piece by interfering with a surface of the movement supporter.

In addition, an assembly wing may protrude on either side surface of the movement supporter, and the assembly wing may be disposed at a lower part of the guide step.

Furthermore, the assembly wing may interfere with the assembly protrusion.

In addition, the movement supporter may include a connector holder covering the door connector. The connector holder may align the door connector so that the door connector is directed in a certain direction.

Furthermore, the mounting base may include a restraint maintaining part, which is moved along the seating surface to interfere with a part of the movement supporter disposed at the operation position to restrict the movement of the movement supporter.

In addition, the movement supporter may include an operation lever protruding toward the operation position. When an external force is applied to the operation lever, the movement supporter may be turned and a part of the movement supporter may be separated from the restraint maintaining part.

Furthermore, the release lever may be disposed inside the operation lever. The connection bridge may be connected to the operation lever.

As described above, the doors of a home appliance and the home appliance including the same according to the present disclosure have the following effects.

In the present disclosure, the door connector connected to the electronic component in the door, and the relative connector (main body connector or external connector) assembled with the door connector may be stored in the door. Accordingly, since the connectors do not need to be stored in a narrow space provided at a side surface or a lower portion of the main body of the home appliance, the storage performance of the connectors can be improved.

In the present disclosure, the connectors are stored in the door, not the main body of the home appliance. Accordingly, the connectors can be less affected by harsh environments of the main body where the temperature and the humidity are excessively high or low. Accordingly, the durability of the connectors can be improved, and the operation reliability of the connectors can be improved.

In addition, in the present disclosure, the door connector may be moved in a constant path along the mounting base disposed in the door. The door connector and the relative connector assembled to each other are disposed on a preset regular path, so the fabricator can easily predict the storage position of the connectors. Accordingly, the maintainability of the connectors can also be improved.

Furthermore, since the door connector and the relative connector assembled to each other are stored/discharged along the constant regular path, it is possible to prevent the connectors from deviating from the preset movement path and covering the window disposed at the central portion of the door. Accordingly, the aesthetic feeling of the door and the home appliance can also be improved.

Specifically, in the present disclosure, the door connector and the relative connector may be disposed in the edge portion (installation region) provided around the window of the door. Therefore, the door connector and the relative connector can be covered by the edge portion when being located in the storage position, so it is possible to prevent outward exposure of the door connector and the relative connector.

In addition, when the door connector is moved along the connector storage part to the operation position, the door connector may be exposed outside the door. The fabricator can assemble or separate the outward exposed door connector to/from the relative connector, so assembly/separation of the connectors can be easily performed.

Specifically, in the present disclosure, since the assembly surface is moved toward the connector inlet of the connector storage part, the door connector is exposed outside the assembly surface when being moved to the operation position. Therefore, the fabricator does not need to check the directionality of the door connector, so high skill in the assembly operation of the connectors is not required and the workability can be improved.

In addition, in the present disclosure, the door connector and the relative connector coupled thereto may be fixed to various positions by the storage fixation portion provided along the connector storage part. Accordingly, the mounting depth of the door connector and the relative connector can be varied, and a variety of extra lengths of the wires connected to the connectors can be accommodated. Therefore, the assembly compatibility of the connectors can be improved.

Furthermore, the storage fixation portion of the present disclosure may be provided on the seating surface of the mounting base on which the movement supporter is seated, and on a surface of the movement supporter facing the seating surface. As described above, the storage fixation portion is stored on the seating surface of the mounting base, so the storage fixation portion can be formed by using all of the area of the seating surface. Therefore, the assembly stability can be improved by increasing the size of the storage fixation portion, and even when the size of the storage fixation portion is increased, the whole size of the connector module is not increased, which is an advantage.

At this point, the vertical surface of a sawtooth shape stands at the storage fixation portion, and the vertical surface may hold the movement supporter to restrict movement of the movement supporter. Accordingly, the movement supporter and the door connector can remain firmly fixed to various positions by the storage fixation portion and can be prevented from being arbitrarily separated by an external force.

In addition, the movement supporter includes the release lever. When the release lever is pressed, the movement supporter can be released from the locked state of the storage fixation portion. The fabricator can pull the movement supporter by pressing the release lever to move the movement supporter from the storage position to the operation position. As described above, since the fabricator can perform the moving work of the movement supporter at a one-touch manner, the workability of the connector module is excellent, which is an advantage.

Furthermore, the assembly wing of the movement supporter may be disposed at the lower part of the guide step of the mounting base. Since the guide step covers the assembly wing, the movement supporter can be prevented from being separated in a direction opposite to a mounting direction, and the guide step can guide the movement of the movement supporter. Therefore, the operation reliability of the movement supporter can be improved.

Furthermore, in the present disclosure, the door connector is mounted to the movement supporter first and then is moved with the movement supporter along the mounting base. The structure to move the door connector should be provided in the movement supporter and the mounting base, and thus the existing door connector can be used. Therefore, the present disclosure has the effect of high compatibility of the connector.

Furthermore, in the present disclosure, the mounting base includes the mounting stopper, and the movement range of the door connector can be limited. Accordingly, the door connector and the relative connector can be prevented from being moved and inserted too deeply into the door.

### BRIEF DESCRIPTION OF THE DRAWINGS

FIG. 1 is a perspective view illustrating an embodiment of a home appliance according to the present disclosure.

FIG. 2 is a perspective view illustrating the embodiment of the present disclosure with a separated side cover constituting the embodiment.

FIG. 3 is a perspective view illustrating a lower door constituting the embodiment of the present disclosure.

FIG. 4 is an exploded perspective view illustrating main components of the lower door constituting the embodiment of the present disclosure.

FIG. 5 is a perspective view, in greater detail than FIG. 4, illustrating the main components of the lower door constituting the embodiment of the present disclosure.

FIG. 6 is a perspective view illustrating a structure of the lower door, an image acquisition module, a connector module, a main wire, and a connector wire constituting the embodiment of the present disclosure.

FIG. 7 is a perspective view illustrating the internal part of the lower door without a rear frame and an inner frame of the lower door constituting the embodiment of the present disclosure.

FIG. 8 is a sectional view illustrating the internal structure of the lower door constituting the embodiment of the present disclosure.

FIG. 9 is a perspective view illustrating an embodiment of the connector module constituting the door for a home appliance according to the present disclosure.

FIG. 10 is an exploded-perspective view illustrating a mounting base, a movement supporter, a door connector, and a main connector constituting an embodiment of the connector module of the present disclosure.

FIGS. 11 to 13 are operational state views sequentially illustrating a process in which the movement supporter is moved from a storage position to an operation position in the embodiment of the connector module according to the present disclosure.

FIGS. 14 to 17 are operational state views sequentially illustrating a process in which the connector module of the embodiment of the present disclosure is moved from the storage position to the operation position and then coupled to the main connector.

FIG. 18 is a concept view illustrating a restraint maintaining part constituting the embodiment of the connector module of the present disclosure, which is changed from a restricting state relative to the movement supporter to a releasing state.

FIG. 19 is a perspective view illustrating a structure of the lower door to which the embodiment of the connector module of the present disclosure is applied.

FIG. 20 is a perspective view illustrating a second embodiment of the connector module constituting the door for a home appliance according to the present disclosure.

FIG. 21 is a perspective view illustrating another embodiment of the home appliance according to the present disclosure.

### DETAILED DESCRIPTION

The present disclosure relates to one or more doors for an appliance, e.g., a home appliance. For example, the home appliance can include a storage space therein. The door can open and close the storage space. The door can be applied to various home appliances such as a cooking appliance, a refrigerator, a freezer, a kimchi refrigerator, a plant cultivating apparatus, Styler®, a washing machine, etc. In some examples, the door can be applied to a door of furniture or an entrance door.

The present disclosure relates to doors for a home appliance. Herein, the home appliance may include a storage space therein. The door may be disposed in front of the storage space and open and close the storage space.

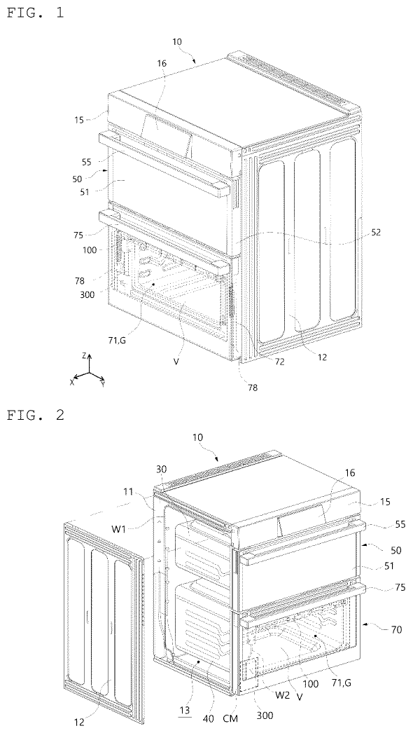

Herein, the front side may be a direction toward a user when the user is located in front of the home appliance. Referring to FIG. 1, an X-axial direction may be a forward direction. A Y-axial direction may be a width direction of a door 50, 70. A Z-axial direction may be a height direction of the door 50, 70. Hereinbelow, the present disclosure will be described based on the directions.

In some implementations, the door includes two doors 50 and 70, but the door of the present disclosure can also be applied to a home appliance equipped with a single lower door 70. Hereinafter, the present disclosure will describe an example in which two doors 50 and 70 are applied to a cooking appliance. Furthermore, a door at a relatively upper side of the two doors 50 and 70 can be called an upper door 50, and a door at a lower side can be called a lower door 70.

In some implementations, an electronic component can be disposed in the lower door 70 of the doors 50, 70. The electronic component can provide various functions to the lower door 70. For example, when the electronic component is an image acquisition module 100, the image acquisition module 100 can be used to obtain an inside image through a storage space. The lower door 70 can include the inner illuminance of the storage space. In some examples, the image acquisition module 100 can include an image sensing device 170 and a lighting device 180.

In some implementations, a display device can be disposed at the lower door 70 as an electronic component. The display device can provide the information of the home appliance to a user. The user can input an operational command through the display device.

The image acquisition module 100 or a part of the display device can be provided in the lower door 70. At this point, the electronic component such as the image acquisition module 100, the display device, or the like can receive and transmit an electric signal with a main controller provided in a main body of the home appliance, or can be connected to the main body with a wire to supply power.

At this point, a connector 370, 390 can be connected to the wire. The connector 370, 390 can include a door connector 370 disposed in the lower door 70 and a main connector disposed in the main body. The door connector 370 can be assembled with the main connector to be electrically connected thereto. On the other hand, the door connector 370 may not be assembled with the main connector, but an external connection connector. Herein, both the main connector and the connection connector will be called a relative connector 390.

Hereinbelow, it will be described that the electronic component disposed in the lower door 70 is the image acquisition module 100 as an example.

Referring to FIG. 1, the view illustrates a cooking appliance equipped with the doors 50 and 70. A main body 10 of the cooking appliance can be roughly shaped into a hexahedral form. In some examples, the main body 10 of the cooking appliance can include two doors 50 and 70. The two doors 50 and 70 can be disposed at different heights. The two doors 50 and 70 can serve to respectively shield different storage spaces 31 and 41.

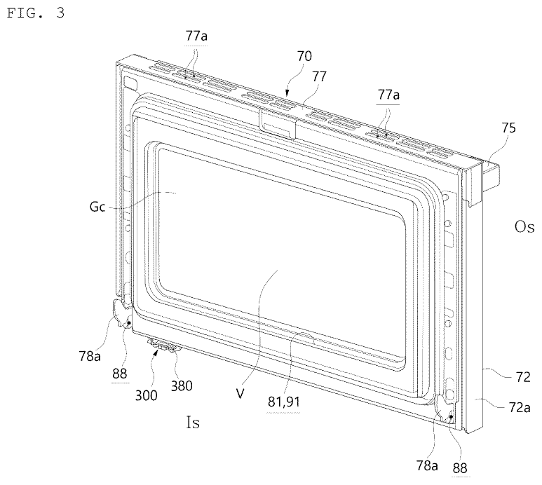

FIG. 2 illustrates a separated state of a side cover 12 constituting the main body 10 of the cooking appliance. When the side cover 12 is separated, an internal space 13 of the main body 10 of the cooking appliance can be exposed. Two cabinets 30 and 40 can be disposed inside the inside space 13 at different heights. The two cabinets 30 and 40 can include the storage spaces 31 and 41 separated from each other. In some implementations, the inside space 13 can include one cabinet or three or more cabinets 30 and 40. In some implementations, the two cabinets 30 and 40 can be disposed transversely. Reference numeral 11 indicates a rear cover constituting the main body 10 of the cooking appliance.

An upper panel 15 can be provided at an upper portion of the cooking appliance. The upper panel 15 can be disposed on an upper end portion of a front surface of the cooking appliance. The upper panel 15 can include an operating part 16. The operating part 16 can be used to operate functions of the cooking appliance and display a state of the cooking appliance. The operating part 16 can be composed of a display capable of being operated in a touch manner. In some implementations, the operating part 16 can include a knob rotatably moved. In some implementations, the operating part 16 can be omitted, and the display device can be disposed at the lower door 70.

The upper panel 15 can be connected to a main wire W1. The main wire W1 can connect the operating part 16 and a main controller to each other. In some examples, the main wire W1 can connect the operating part 16 to the electronic component of the lower door 70, such as the image acquisition module 100. The main wire W1 can be connected to a connection wire W2 described below, through a door wire W2.

The two cabinets 30 and 40 can be classified into a first cabinet 30 and a second cabinet 40. The first cabinet 30 and the second cabinet 40 can be disposed in the inside space 13 at different heights. An upper storage space can be provided in a first cabinet 30. A lower storage space can be provided in the second cabinet 40. In some examples, the upper storage space and the lower storage space can be separated from each other, and can be open only at the front portions.

The upper door 50 can be disposed in front of the first cabinet 30. The lower door 70 can be disposed in front of the second cabinet 40. In some implementations, the upper door 50 and the lower door 70 can be operated in a kind of pull-down method in which each upper end is vertically swung on a lower end thereof. In some implementations, the upper door 50 and the lower door 70 can be operated in a side swing method in which each door is opened sideways.

In the upper door 50, a front surface 51 of the upper door 50 can have a structure allowing the upper storage space to be visible. For example, the front surface 51 of the upper door 50 has a glass panel structure, and a user can observe the inside part of the upper storage space through the upper door 50. In some examples, the front surface 51 of the upper door 50 can be made of dark materials or be coated with a separate film, thereby preventing the upper storage space from being visible from the outside. Reference numeral 55 indicates a first handle to open and close the upper door 50.

The lower door 70 can be disposed below the upper door 50. The lower door 70 can be disposed in front of the second cabinet 40. The lower storage space can be visible through a front surface of the lower door 70. The user can observe the inside of the lower storage space through the front surface of the lower door 70.

In some implementations, the lower door 70 can include a window V. The window V allows the lower storage space to be visible from the outside space and can be made of a transparent material. The window V can be understood as a part of a front panel Ga constituting the front surface of the lower door 70. The window V can be provided in a central portion of the front panel Ga. For example, an edge portion of the front panel Ga can have a material with higher surface roughness unlike the window V. Otherwise, a separate opaque film can be applied to the edge portion of the front panel Ga. Then, excluding the window V, the edge portion of the front panel Ga prevents the lower storage space form being visible.

In some implementations, the edge of the front panel Ga corresponding to the outside part of the window V can be covered by a door frame 72, 77, 80, 90. Herein, the outside part of the window V can be the edge portion of the front panel Ga that surrounds the edges of the window V with the window V as the center.

In some implementations, the lower door 70 can be made of dark materials or coated with a separate film, thereby preventing the lower storage space from being visible from the outside space. In some implementations, in the lower door 70, the door panel G which will be described below can be omitted, and an opaque metallic or nonmetallic plate can define the front surface thereof. Also, in this case, the lower storage space may not be visible from the outside space.

FIG. 2 illustrates the image acquisition module 100 and the connector module 300 which are mounted inside the lower door 70. Although FIG. 2 illustrates the image acquisition module 100 and the connector module 300 indicating positions where the image acquisition module 100 and the connector module 300 are mounted inside the lower door 70, the image acquisition module 100 and the connector module 300 may not be visible from the front space of the cooking appliance. This is because, as described above, the edge portion of the front panel Ga excluding the window Vis opaque. Reference numeral 75 indicates a second handle to open and close the lower door 70.

In some examples, the image acquisition module 100 can be disposed in the upper door 50. In some examples, two image acquisition modules 100 can be disposed in the upper door 50 and the lower door 70 respectively. In some examples, the image acquisition module 100 and the connector module 300 can be separately disposed in the upper door 50 and the lower door 70.

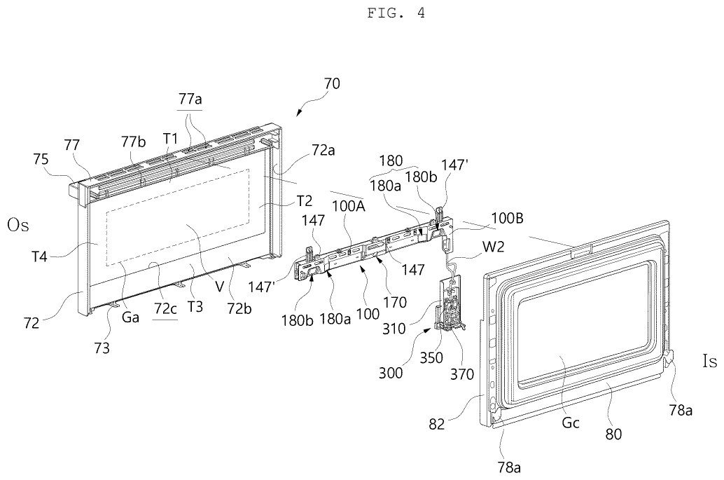

FIG. 3 illustrates the lower door 70 when viewed from the rear side. The front surface of the lower door 70 can have a flat surface structure. In some examples, the surface of the front panel Ga can define the front surface of the lower door 70.

The window V can be provided in the central portion of the front surface of the lower door 70. The window V can be a portion made of a transparent or translucent material so that the lower storage space can be visible from the outside space. The window V can be located through a central portion of a plurality of panels constituting the door panel G. FIG. 3 illustrates the window V provided in a central portion of a second rear panel Gc constituting the door panel G.

A frame of the lower door 70 can be formed from the door body. The door body can include the door frame 72, 77, 80, 90 and the door panel G. The door body can have roughly a hexahedral structure when the door frame 72, 77, 80, 90 and the door panel G are assembled.

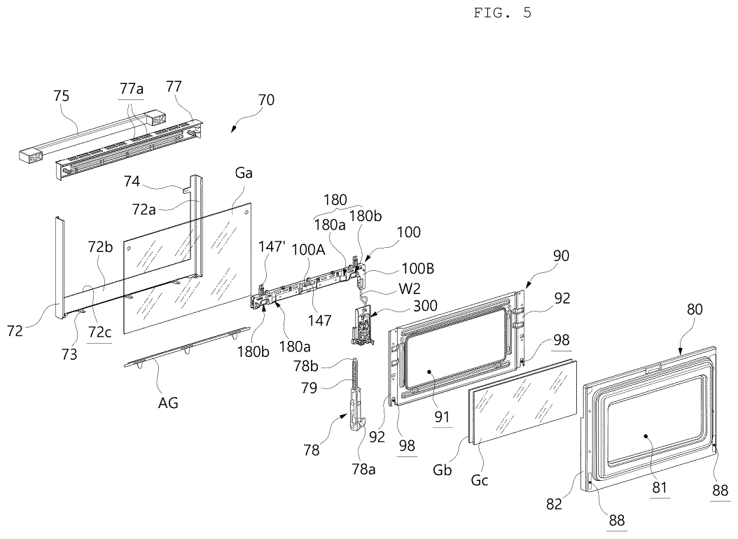

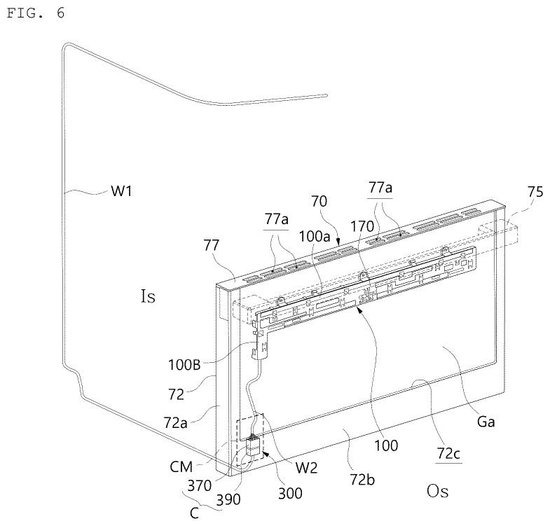

Referring to FIGS. 4 and 5, the door frame 72, 77, 80, 90 can include multiple frame parts. In some implementations, the door frame 72, 77, 80, 90 can include a front frame part 72, a rear frame part 80, an inner frame part 90, and the upper frame part 77. The frame parts can be coupled to each other to provide one door frame 72, 77, 80, 90.

Herein, “front” is based on the front side of the lower door 70. For reference, in the entire drawings including FIG. 4, “Is” indicates the inside area of the lower door 70 facing the storage space, and “Os” indicates the outside area of the home appliance, i.e., the outside space of the lower door 70.

The front frame part 72 can be disposed at the front part of the door frame 72, 77, 80, 90. More specifically, the front frame part 72 can form a front frame of the door frame 72, 77, 80, 90. The front frame part 72 can be formed roughly in a rectangular frame shape. The front frame part 72 can be formed in a rectangular frame shape with an upper portion and a lower portion open upward and downward, respectively. A pair of front side plates 72a can be provided at both sides of the front frame part 72. The pair of front side plates 72a can stand vertically. A front lower plate 72b can connect the pair of front side plates 72a to each other while being located therebetween. The front side plates 72a and the front lower plate 72b are connected to each other to form roughly a “U” shape.

A front opening 72c can be provided between the front side plates 72a and the front lower plate 72b. The front opening 72c can be an empty space open in a longitudinal direction. The front panel Ga constituting the door panel G (referring to FIG. 1) can be disposed in the front opening 72c. It can be understood that an open portion of the front opening 72c is filled with the front panel Ga.

More specifically, the region of the door panel G is wider than the region of the front opening 72c, so a part of the front side plates 72a and a part of the front lower plate 72b can be stacked with the door panel G respectively. The front side plates 72a, the front lower plate 72b, and the front panel Ga can be coupled to each other by an adhesive or an adhesive tape. FIG. 4 illustrates the front panel Ga and the front frame part 72 stacked to each other. FIG. 4 illustrates the front panel Ga with a lower portion covering most of a rear surface of the front lower plate 72b.

With the second front side plates 72a of the front frame part 72 located in the center, the front panel Ga can be disposed at one side. The second handle 75 can be disposed at the opposite side of the second front side plates 72a. Herein, a separate fastener can pass through the second front side plates 72a and a panel fastening hole G2a′ of the front panel Ga and then can be fastened to a handle assembly part 75a of the second handle 75.

A lower frame part 73 can be provided at a lower end of the front frame part 72. The lower frame part 73 can be a part of the front frame part 72 or a separate object. The lower frame part 73 can have a shape bent from the lower end of the front frame part 72. The lower frame part 73 can include a connector inlet 73a. The connector inlet 73a can be provided at an operation position described below. An operator can access a connector storage portion CM through the connector inlet 73a.

The image acquisition module 100 can be disposed in rear of the front panel Ga. Herein, the image acquisition module 100 can be adhered to a rear surface of the front panel Ga. More specifically, a partial surface of a front surface of the image acquisition module 100 and a partial surface of the rear surface of the front panel Ga can be adhered to each other.

For reference, the image acquisition module 100 can include an image sensing device 170. The image acquisition module 100 can include a plurality of lighting devices 180 with the image sensing device 170. The plurality of lighting devices 180 increases the illuminance of the lower storage space so that the image sensing device 170 acquires a clearer image. In some examples, the plurality of lighting devices 180 can include a first lighting part 180a and a second lighting part 180b. In some examples, the image sensing device 170 or the plurality of lighting devices 180 can be omitted.

Referring to FIG. 5, a rear panel Gc of insulation panels Gb and Gc constituting a rear surface of the lower door 70 can be exposed rearward. The rear panel Gc can also include a window V. The window V of the rear panel Gc and the window V of the front panel Ga can be successively disposed at a predetermined distance therebetween and assigned with the same reference numeral. Although no reference numeral is assigned, in the insulation panels Gb and Gc, the inner panel Gb unexposed outward of the lower door 70 can also have a window V.

Describing the door panel G with reference to FIG. 5, the door panel G may include 3 panels in total. The 3 panels may include the front panel Ga disposed at the foremost side, the inner panel Gb disposed in the lower door 70, and the rear panel Gc disposed at the rearmost side. Among the panels, the front panel Ga may be exposed forward (a front side of the main body 10, X-axial direction in FIG. 1). The rear panel Gc may be exposed rearward (a rear side facing the lower storage space) on the contrary to the front panel.

The inner panel Gb and the rear panel Gc can define the insulation panels Gb and Gc. The inner panel Gb and the rear panel Gc can be stacked to each other at a constant distance. In addition, an empty space between the inner panel Gb and the rear panel Gc can become a vacuum, thereby increasing insulation performance. In some implementations, the insulation panels Gb and Gc can include only the rear panel Gc without the inner panel Gb.

Installation regions T1 to T4 can be provided between the front panel Ga and the insulation panels Gb and Gc. The installation regions T1 to T4 can be provided in the empty space between the front panel Ga and the insulation panels Gb and Gc. The installation regions T1 to T4 can be a portion where the image acquisition module 100 and the connector module 300 are disposed. In some implementations, the insulation panels Gb and Gc are omitted, and the installation regions T1 to T4 can be disposed between the front panel Ga and the door frame 72, 77, 80, 90.

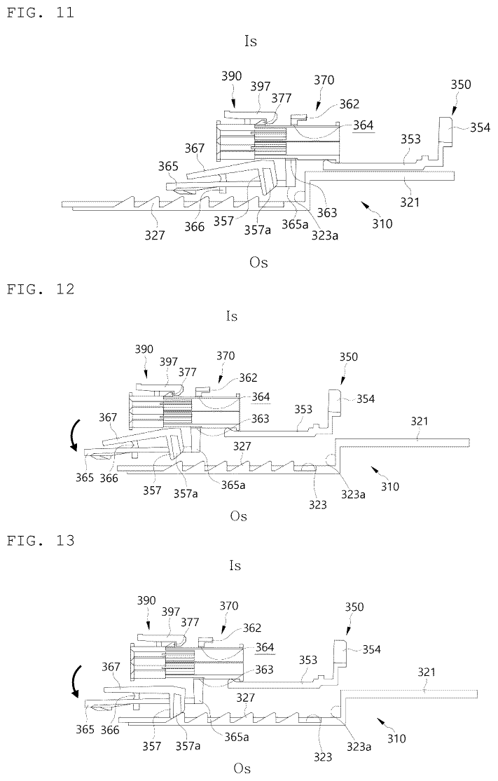

Referring to FIG. 10, a cooling flow path A1 can be provided between the front panel Ga and the insulation panels Gb and Gc. The cooling flow path A1 can be the entire space between the front panel Ga and the insulation panels Gb and Gc. The installation regions T1 to T4 can be disposed outside the window V with the window V as the center. Therefore, the cooling flow path A1 can be wider than the installation regions T1 to T4, and the installation regions T1 to T4 can constitute a part of the cooling flow path A1.

Air can flow into the door panel G along the cooling flow path A1. Accordingly, the cooling flow path A1 can be a flowing space in which air flows.

In some implementations, the door panel G may not be provided as a separate object, but can be a part of the door frame 72, 77, 80, 90. The door panel G can be integrally provided with the door frame 72, 77, 80, 90. In this case, the door panel G may not be made of a transparent material and can shield the lower storage space to prevent the lower storage space from being exposed. The door panel G can be made of the same material as the door body. For example, the door panel G can have a metal or nonmetal plate structure.

In FIG. 4, the installation regions T1 to T4 are indicated. The installation regions T1 to T4 are portions where the image acquisition module 100 and the connector module 300 are disposed, and a dotted line in FIG. 4 is expressed to help understand the installation regions T1 to T4. In FIG. 4, the installation regions T1 to T4 are illustrated at the rear surface of the front panel Ga, but the installation regions T1 to T4 are actually provided in the empty space between the plurality panels and the door frame 72, 77, 80, 90.

Herein, the upper frame part 77 of the door frame 72, 77, 80, 90 can cover a part of an upper end of the rear surface of the front panel Ga. A part of the installation regions T1 to T4 can be formed in a portion not covered by the upper frame part 77. More specifically, in the installation regions T1 to T4, the first installation region T1, T3 can be provided at a lower portion of the upper frame part 77 that is not covered by the upper frame part 77.

The installation regions T1 to T4 can include (i) the first installation region T1, T3 formed in a first direction along an edge of the window V, and (ii) a second installation region T2, T3 formed in a second direction different from the first direction along an edge of the window V. In some examples, the first direction is a transverse direction (a transverse width direction of the lower door 70), and the second direction is a vertical direction (a height direction of the lower door 70).

The first installation region T1, T3 can be formed at each of an upper portion T1 and a lower portion T3 of the window V with the window V as the center. The second installation region T2, T3 can be formed at each side portion of the window V with the window V as the center. In other divisions, the installation region T1 to T4 can be divided into (i) the upper region T1 provided at the upper portion of the window V, (ii) the right region T2 provided at the right portion of the window V, (iii) the lower region T3 provided at the lower portion of the window V, and (iv) the left region T4 provided at the left portion of the window V. The division is based on FIG. 4.

The first installation region T1, T3 and the second installation region T2, T3 can be connected to each other. Opposite end portions of the first installation region T1, T3 and the opposite end portions of the second installation region T2, T3 are connected to each other. Accordingly, the installation regions T1 to T4 can be formed in connected spaces. Then, the image acquisition module 100 and the connector module 300 can be disposed to pass through the multiple installation regions T1 to T4.

In some examples, a main unit 100A, i.e., a part of the image acquisition module 100 can be disposed in the first installation region T1, T3. A part of a connection unit 100B, i.e., a remaining part of the image acquisition module 100 can be disposed in the second installation region T2, T3. The image acquisition module 100 and the connector module 300 can be electrically connected to each other through the door wire W2. In some implementations, the connector module 300 is disposed in the second installation region T2, T3.

At least a part of the installation regions T1 to T4 can be provided at a region where a part of the door frame 72, 77, 80, 90 covers a rear surface of the front panel Ga. At this point, covering, by the rear frame part 80, a part of the image acquisition module 100 can be based on the rear space of the lower door 70, i.e., a direction from the inside space of the lower storage space to the rear surface of the lower door 70 when the lower door 70 is closed.

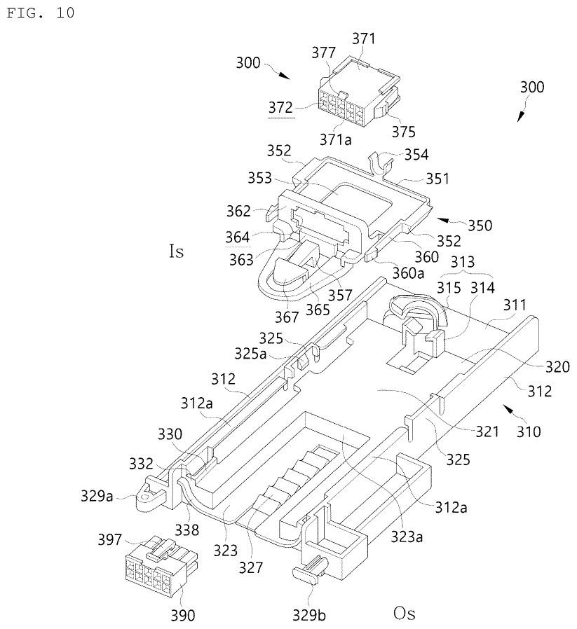

In some implementations, the connector module 300 can be disposed in a part of the second installation region T2, T3, and a part of the first installation region T1, T3. FIG. 9 illustrates the connector module 300 disposed over the right side region T2 provided at the right side portion of the window V, and the lower region T3 provided at a lower portion of the window V Both the right side region T2 and the lower region T3 are provided outside the window V, so the regions may not be exposed outward.

In some implementations, the connector module 300 can be disposed at one of the regions including the upper region T1, the lower region T3, and the left side region T4. In some examples, the connector module 300 does not extend to the lower region T3, and can be disposed in the right side region T2.

Preferably, considering the accessibility of the operator, one end portion of the connector module 300 can be disposed at an outer edge of the installation region T1 to T4. Then, the operator can easily access one end portion of the connector module 300 to assemble or maintain the connector module 300.

The image acquisition module 100 can be disposed in the first installation region T1, T3, and the door wire W2 for allowing signal transmission and power supply between the image acquisition module 100 and the main controller can be disposed in the second installation region T2, T3.

Herein, the front panel Ga can be divided into the window V, and an edge part disposed around the edges of the window V. Herein, the installation regions T1 to T4 can be provided on a rear surface of the edge part. At this point, the edge part can be processed to be opaque. Accordingly, the installation regions T1 to T4 provided at a lower surface of the edge part may not be exposed from the front space of the lower door 70, i.e., from the front space of the cooking appliance. The edge part can be formed by etching a part of the front panel Ga to increase the surface roughness, or by being coated with a separate film, or by being treated opaquely by a painting process.

In some implementations, the upper frame part 77 can be disposed above an upper portion of the front opening 72c. The upper frame part 77 can be coupled to an upper portion of the front frame part 72, more specifically, to the upper ends of the pair of front side plates 72a. The upper frame part 77 can cover a part of an upper end of the rear surface of the front panel Ga. The image acquisition module 100 described below can be fixed to the upper frame part 77. Reference numerals 147 and 147′ indicate module fastening parts to which fasteners are coupled to fix the image acquisition module 100 to the upper frame part 77.

The frame outlet 77a can be open in the upper frame part 77. The frame outlet 77a can be an outlet through which air passing through the cooling flow path A1 formed in the lower door 70 is discharged outward. The frame outlet 77a can be connected to the installation regions T1 to T4 as described below.

Referring to FIG. 5, the lower door 70 can include a door hinge 78. The door hinge 78 can allow the lower door 70 to be connected to the main body 10 of the cooking appliance to be turned. The door hinge 78 can be disposed in the lower door 70, more specifically, in an empty space formed between the front frame part 72 and an inner frame part 90. A door hinge arm 78a can protrude on the door hinge 78. The hinge holding arm 78a can pass through an inner hinge passage part 98 of the inner frame part 90 and a rear hinge passage part 88 of the rear frame part 80 in order, and then can be fixed by being caught by the main body 10 of the cooking appliance. Reference numeral 79 is a hinge spring 79 and can be fitted over a spring guide 78b of the door hinge 78. The hinge spring 79 can provide an elastic force to the door hinge 78 in a direction of closing the lower door 70 while being tensioned when the lower door 70 is opened.

With the door panel G located in the middle, the front frame part 72 can be disposed at the front of the door panel G, and the inner frame part 90 and the rear frame part 80 can be disposed at the rear of the door panel G. The inner frame part 90 and the rear frame part 80 are spaced apart from each other (i) to form an insulation space therebetween, and (ii) to fix the second insulation panels Gb and Gc. The inner frame part 90 can be disposed between the rear frame part 80 and the front frame part 72, thereby being unexposed outward.

The rear frame part 80 can be roughly formed in a rectangular frame shape. When the lower door 70 is closed, the rear frame part 80 can face a front surface of the second cavity. The rear through part 81 can be open on a central portion of the rear frame part 80. The rear through part 81 can have a longitudinally open structure so that the internal space of the lower storage space can be visible through the window V.

Rear side plates 82 can be provided at side surfaces of the rear frame part 80. The rear side plates 82 can be bent forward of the lower door 70. The rear side plates 82 can be disposed inside the front side plates 72a. Reference numeral 88 is the rear hinge passage part 88 through which the door hinge arm 78a of the door hinge 78 passes.

The rear frame part 80 can cover a part of the connector module 300. Accordingly, even when the user opens the lower door 70, the connector module 300 may not be exposed through the window V.

The inner frame part 90 can be coupled to the rear frame part 80. The inner frame part 90 can be formed roughly in a rectangular frame shape. When the lower door 70 is closed, the inner frame part 90 can stand vertically at a distance from the rear frame part 80. An inner through part 91 can be open on a central portion of the inner frame part 90. The inner through part 91 can have a longitudinally open structure so that the internal space of the lower storage space can be visible through the window V.

Inner side plates 92 can be provided at side surfaces of the inner frame part 90. The inner side plates 92 can be bent forward of the lower door 70. The inner side plates 92 can overlap with the rear side plates 82. At the overlapped portions, the inner side plates 92 and the rear side plates 82 can be coupled to each other in a method such as welding, adhesion, or fastening by a separate fastener.

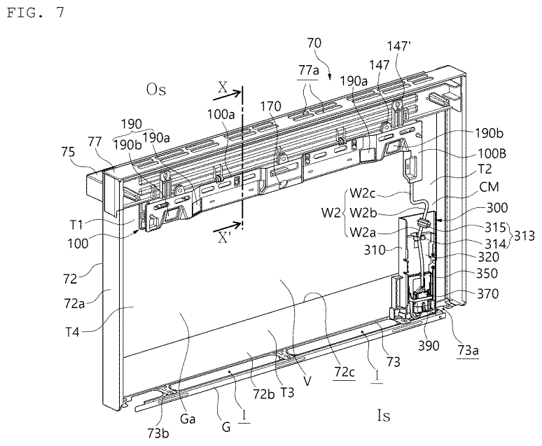

FIG. 6 illustrates the lower door 70 when viewed from the front space of the lower door 70. A wire to achieve power supply or signal transmission can be disposed in the main body 10 and the lower door 70 of the home appliance. The wire can include the main wire W1 to connect the connector module 300 of the lower door 70 to the main controller in the main body 10, and the door wire W2 to connect the connector module 300 to the image acquisition module 100.

When necessary, the operator can separate the main wire W1 from the connector module 300, and perform maintenance/repairing to the image acquisition module 100. For reference, FIG. 6 is a perspective view illustrating the image acquisition module 100. However, the image acquisition module 100 can be shielded by the edge part of the front panel Ga. FIG. 6 illustrates the door connector 370 constituting the connector module 300 assembled to the relative connector 390.

The connector module 300 can be disposed in the installation region T1 to T4 of the lower door 70. More specifically, the connector storage portion CM can be provided in the installation region T1 to T4. The connector module 300 can be disposed in the connector storage portion CM. The connector storage portion CM can be an empty space, i.e., a part of the installation region T1 to T4. In some implementations, the connector storage portion CM can be a kind of bracket integrated with the installation region T1 to T4, or provided as a separate object.

In FIG. 6, the connector storage portion CM can be disposed close to a lower end portion of a side surface of the lower door 70. When the connector storage portion CM is disposed at the lower end portion of the lower door 70, the operator can access the connector module 300 through the lower portion of the lower door 70. When the connector storage portion CM is disposed at the lower end portion of the lower door 70, the connector module 300 can be prevented from being exposed outward normally. Furthermore, as described below, the connector inlet 73a of the connector storage portion CM can open through the lower end portion of the lower door 70, so the operator can easily access the connector module 300.

In some implementations, the connector storage portion CM can be disposed close to an upper end portion of a side surface of the lower door 70. Furthermore, the connector inlet 73a of the connector storage portion CM can be open through the side surface of the lower door 70.

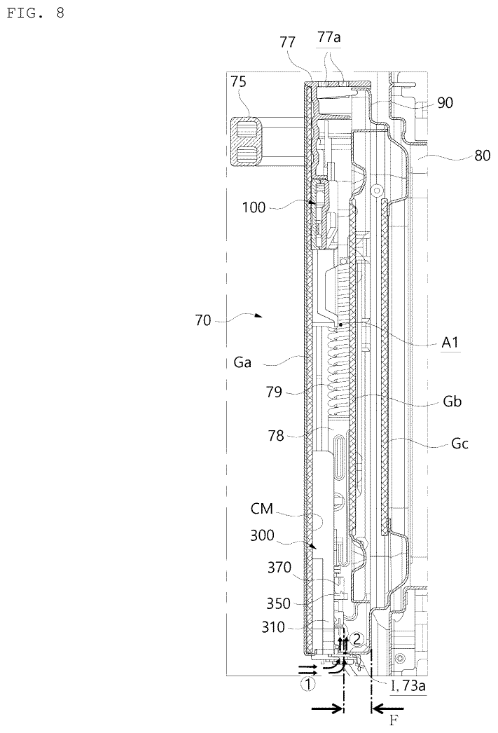

FIG. 7 illustrates the connector module 300 disposed in the connector storage portion CM. Herein, the view illustrates the relative connector 390 separated from the door connector 370 of the connector module 300. The door connector 370 can be disposed at a lower end portion of the connector storage portion CM. Accordingly, the relative connector 390 can be easily assembled to and separated from the door connector 370.

As illustrated in FIG. 7, the connector storage portion CM can be disposed outside the window V. Accordingly, the connector storage portion CM and the connector module 300 disposed in the connector storage portion CM may not be exposed outward, or the exposed region can be minimized.

In the embodiment, the door connector 370 of the connector module 300 may be moved between a storage position and an operation position. Herein, the storage position is a position where the connector assembly C is moved to the inside part of the connector storage part CM not to be exposed outward. Furthermore, the operation position is a position where the door connector 370 is moved to the connector inlet 73a of the connector storage part CM to be assembled to/separated from the relative connector 390 and the assembly surface 371a of the door connector 370 is exposed outward. Herein, the storage position may be a first position, and the operation position may be a second position.

The lower frame part 73 can be provided at the lower end of the lower door 70. The connector inlet 73a of the connector storage portion CM can be open in the lower frame part 73. As illustrated in FIG. 9, the connector inlet 73a can be formed by vertically penetrating the lower frame part 73. The connector inlet 73a can be a part of air inlets I, i.e., a plurality of inlets of the cooling flow path A1 which are open in the lower frame part 73. Reference numeral 73b indicates a bracket provided in the lower frame part 73 to mount the air guide G. Furthermore, reference numeral 190 is a lighting cover to cover each lighting device 180.

The connector module 300 can include the door connector 370. The door connector 370 can be connected to a first end portion of the door wire W2. The first end portion of the door wire W2 can be coupled to the door connector 370, and a second end portion can be connected to the image acquisition module 100. FIG. 6 illustrates the second end portion of the door wire W2 connected to the image sensing device 170 of the image acquisition module 100. In some examples, the second end portion of the door wire W2 can be connected to each lighting device 180. In some examples, the second end portion of the door wire W2 can be connected to another electronic component such as the display device, etc.

The door connector 370 can be disposed in the connector storage portion CM. The door connector 370 can be moved between the first position and the second position in the connector storage portion CM. The first position can be the storage position. The second position can be the operation position. For reference, FIG. 9 illustrates the door connector 370 disposed at the storage position.

In some examples, the door connector 370 can be mounted to a movement supporter 350 and moved with the movement supporter 350. The movement supporter 350 can be mounted to the connector storage portion CM. Herein, the movement supporter 350 can be moved along a mounting base 310 disposed in the connector storage portion CM. In some examples, the movement supporter 350 can be omitted, and the door connector 370 can be directly disposed in the mounting base 310. The structures of the movement supporter 350 and the mounting base 310 will be described below.

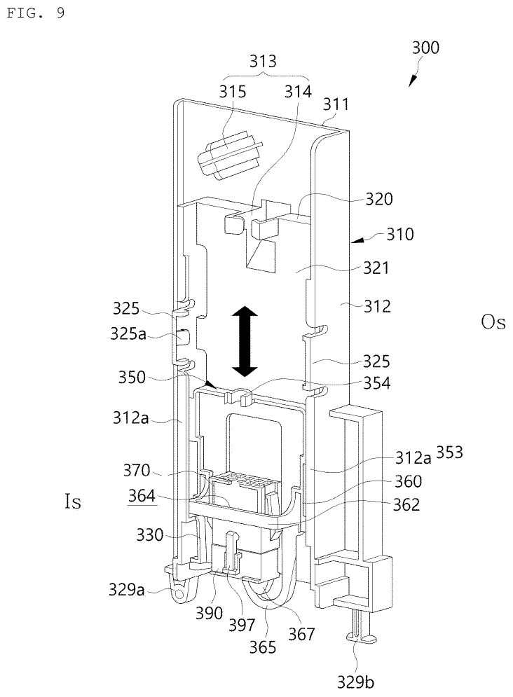

FIG. 8 illustrates the connector storage portion CM provided at the lower portion of the lower door 70. The connector storage portion CM can be provided around a lower inlet of the cooling flow path A1. The door connector 370 can be disposed in the connector storage portion CM. To move the door connector 370, there is a need to access the connector storage portion CM. In some examples, the connector inlet 73a can be open in the lower portion of the lower door 70.

Herein, the width of the connector inlet 73a may be larger than the thickness of the door connector 370. Herein, the width of the connector inlet 73a is based on the transverse direction of the lower door 70 and may be the transverse width (X-axial direction in FIG. 1) based on FIG. 8. The thickness of the door connector 370 is based on the longitudinal direction of the lower door 70. When the width of the connector inlet 73a is larger than the thickness of the door connector 370, the connector inlet 73a may have a clearance. The clearance may be an operation space F. FIG. 8 illustrates the width of the operation space F. The fabricator may access the door connector 370 through the operation space F.

The operation space F can be formed between a surface of the door connector 370 and an edge of the connector inlet 73a. The operation space F can be an empty space between the surface of the door connector 370 and the inner frame part 90. The operation space F can be a space through which the operator can access the door connector 370 and an air inlet through which external air is introduced into the lower door 70 at the same time.

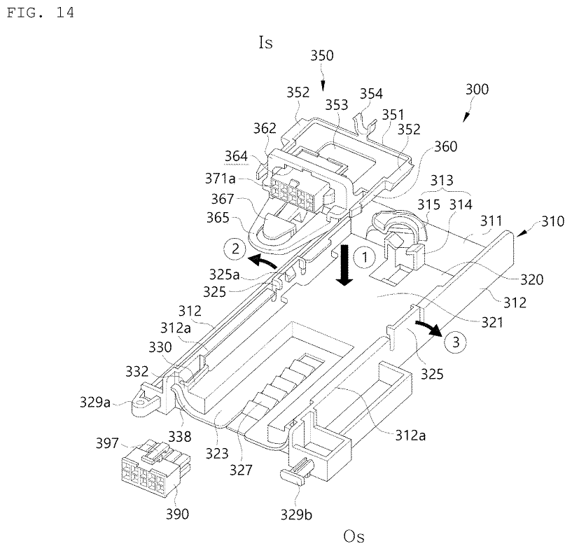

FIG. 9 illustrates an example of the connector module 300. The connector module 300 can be disposed between the main wire W1 and the door wire W2. More specifically, the relative connector 390 to which the main wire W1 is connected can be connected to the door connector 370 to which the door wire W2 is connected, in the connector module 300. FIG. 11 illustrates the door wire W2 and the main wire W1 electrically connected to each other with the door connector 370 and the relative connector 390 assembled.

For convenience of description, describing the door connector 370 of the connector module 300 with reference to FIG. 10, the door connector 370 may have roughly a hexahedral structure. The door connector 370 may include a connector body 371 of an insulator in which a plurality of terminals (not illustrated) is disposed. Terminal wires (not illustrated) may be connected to the terminals. The terminal wires may constitute the door wire W2. FIG. 10 illustrates terminal holes 372 into which the terminals are inserted.

An assembly surface 371a can be provided on a front surface of the door connector 370. The assembly surface 371a can be a surface facing the connector inlet 73a. The assembly surface 371a can be a portion assembled with the relative connector 390.

A structure may be disposed on the surface of the door connector 370 to fix the door connector 370 to the movement supporter 350. Specifically, a connector lance part 375 may protrude on a surface of the door connector 370. The connector lance part 375 may pass through a mounting hole 364 provided in the movement supporter 350 and may be fixed by being caught by the opposite side of the mounting hole 364. Then, the door connector 370 is prevented from being separated in the opposite direction, i.e., an upward direction based on FIG. 10. The reference numeral 377 indicates a fastening step for coupling between the door connector and the relative connector.

The connector module 300 can include the mounting base 310. The mounting base 310 can be fixed to the connector storage portion CM. The mounting base 310 can guide the movement of the movement supporter 350 and the movement of the door connector 370. Since the mounting base 310 can be fixed, the mounting base 310 can be moved relatively to the movement supporter 350 and the door connector 370. In FIG. 9, an arrow is a movement direction of the movement supporter 350 and the door connector 370.

The mounting base 310 can guide the movement of the movement supporter 350 and the movement of the door connector 370. The mounting base 310 can be fixed to the connector storage portion CM, thereby preventing the movement supporter 350 and the door connector 370 from also being separated from the connector storage portion CM. The mounting base 310 can guide an extension direction of the door wire W2 as described below.

Describing the mounting direction of the mounting base 310, as illustrated in FIG. 7, a rear surface of the mounting base 310 may face the front space (Os) of the lower door 70. When viewed from the front space (Os) of the lower door 70, the movement supporter 350 and the door connector 370 disposed on the front surface of the mounting base 310 may be covered by the mounting base 310. Of course, since the connector module 300 including the mounting base 310 is disposed outside the window V, the connector module 300 may be covered by an edge portion of the lower door 70.

In some examples, the mounting base 310 can cross a portion of the window V, but a lower surface of the mounting base 310 has a flat surface structure, and the mounting base 310 can cover both the door connector 370 and the movement supporter 350, so the mounting base 310 can be partially exposed to external space (front space of the lower door 70).

The door wire W2 may extend upward of the mounting base 310. The main wire W1 may extend downward of the mounting base 310. The mounting base 310 is disposed adjacent to a lower part of the main body, so an exposure range of the main wire W1 may be reduced.

Referring to FIG. 10, the movement supporter 350 and the door connector 370 can be separated from the mounting base 310. When the movement supporter 350 is mounted to the mounting base 310, the movement supporter 350 can be linearly moved along the mounting base 310. The movement supporter 350 can be separated from the mounting base 310 or assembled with the mounting base 310 only at a specific position. This structure will be described below.

A vertical height of the mounting base 310 in a movement direction of the movement supporter 350 may be formed wider than a transverse width perpendicular to the vertical height. A transverse width of the mounting base 310 may be formed smaller than or equal to the width of the installation region T1 to T4. Accordingly, the mounting base 310 may not be separated from the installation region T1 to T4.

The mounting base 310 does not completely cover the movement supporter 350 and the door connector 370, but may expose the movement supporter 350 and the door connector 370. Referring to FIG. 7, the movement supporter 350 and the door connector 370 may be exposed in a direction (Is) toward the inside space of the main body. However, the connector module 300 is disposed in the connector storage part CM provided in the door, thereby being prevented from being visible from the outside space.

In FIG. 9, the door connector 370 and the relative connector 390 have been moved to the operation position. In the operation position, the door connector 370 may be assembled with or separated from the relative connector 390. When the relative connector 390 is pushed upward from the state illustrated in FIG. 9, the door connector 370 and the movement supporter 350 may be moved with the relative connector 390. The door connector 370, the relative connector 390, and the movement supporter 350 may be moved to the storage position.

Herein, the door connector 370 may be moved in a predetermined section with the movement supporter 350. As described below, a part of the movement supporter 350 may interfere with a mounting stopper 323a (referring to FIG. 11) of the mounting base 310. The mounting stopper 323a of the mounting base 310 may limit the movement range of the movement supporter 350. More specifically, the mounting stopper 323a may limit the depths at which the movement supporter 350 and the door connector 370 are inserted.

The mounting base 310 may include a restraint maintaining part 330 provided at the opposite side of the mounting stopper 323a. When the movement supporter 350 and the door connector 370 are moved to the operation position, the restraint maintaining part 330 may enable the movement supporter 350 and the door connector 370 to be fixed without being separated from the operation position. The structure of the restraint maintaining part will be described below again.

The sum of the length of the door connector 370 and the length of the relative connector 390 may be smaller than or equal to a distance from a lower end of the mounting base 310, i.e. the operation position, to the mounting stopper 323a. Accordingly, the entire connector assembly C may be completely seated on the mounting station 320. The distance from the lower end of the mounting base 310 to the mounting stopper 323a may be longer than the length of the movement supporter 350.

The sum of the length of the part of the door connector 370 protruding outward of the connector inlet 73a and the length of the relative connector 390 may be shorter than or equal to a movement range of the door connector 370. Then, when the door connector 370 is moved to the storage position, the relative connector 390 is also moved to the storage position to prevent the entire connector assembly C from being exposed outward. In other words, when the connector assembly C is moved to the storage position, the relative connector 390 is also moved to the storage position so that the entire connector assembly C may be disposed above the lower end of the mounting base 310.

FIG. 11 illustrates the door connector 370, the relative connector 390, and the movement supporter 350 that have been moved to the storage position. As shown in the drawing, a lower end (left end based on the drawing) of the relative connector 390 may be disposed at a higher portion (right portion based on the drawing) than a lower end (left end based on the drawing) of the mounting base 310. Therefore, the relative connector 390 may be prevented from protruding outward of the connector inlet 73a. On the other hand, the movement supporter 350 is no longer moved in the right direction based on FIG. 11, due to interference with the mounting stopper 323a.

The structure of the mounting base 310 will be described in detail with reference to FIG. 10. A frame of the mounting base 310 may be formed of a base body 311 of a flat plate structure. The mounting station 320 may be disposed on a first surface of the base body 311. A second surface of the base body 311 may be brought into close contact with a surface of the front panel Ga. For example, the second surface of the base body 311 may adhere to the surface of the front panel as a fixation surface. As another example, the base body 311 may be fixed to the door frame 72, 77, 80, 90, not a surface of the front panel Ga.

A guide fence 312 can be provided at either side of the base body 311. The guide fence 312 can stand outside the mounting station 320. The guide fence 312 can be provided in a movement direction of the door connector 370 outside the mounting station 320. In some examples, the guide fence 312 can be provided at either side of the mounting station 320. In some examples, the guide fence 312 can be provided only on either side of the mounting station 320 or can be omitted.

The guide fences 312 may include respective guide steps 312a. The guide steps 312a may be provided at the pair of guide fences 312. The pair of guide steps 312a may protrude in facing directions. The guide steps 312a covers an assembly wing 352 of the movement supporter 350, and the movement supporter 350 may be prevented from being separated from the seating surface 321 in a separating direction (front side Is in FIG. 9).

A first end of each guide step 312a may be adjacent to an assembly piece 325 described below. A second end of the guide step 312a may be adjacent to the restraint maintaining part 330. Therefore, the assembly wing 352 of the movement supporter 350 guided by the guide step 312a may be moved along the guide step 312a below the assembly piece 325 and be disposed adjacent to the restraint maintaining part 330.

The base body 311 may include a wire guide 313. The wire guide 313 may guide a direction in which the door wire W2 extends. The wire guide 313 may protrude from the base body 311. The wire guide 313 may be disposed between the image acquisition module 100 and the door connector 370. The wire guide 313 covers the door wire W2 so that the door wire W2 extends in a preset direction. In the embodiment, since the door connector 370 is moved, a relative distance between the door connector 370 and the fixed wire guide 313 may change.

The base body 311 may include a plurality of wire guides 313. The plurality of wire guides 313 may be provided in an extension direction of the door wire W2. In the embodiment, the plurality of wire guides 313 may include a first guide 314 and a second guide 315.

The first guide 314 may be disposed at an edge of the mounting station 320. The second guide 315 may deviate from the mounting station 320 and be disposed outside the mounting station 320. The door wire W2 may extend toward the image acquisition module 100 while passing through the first guide 314 and the second guide 315 in order.

The first guide 314 and the second guide 315 may be disposed to be offset from each other based on the movement direction of the door connector 370. The first guide 314 may be disposed on a position passing through a central portion of the door connector 370. The second guide 315 may be provided on a position deviating from the center of the door connector 370 and biasing to a side surface of the base body 311, more specifically, to an edge of the door body. The first guide 314 and the second guide 315 may be disposed to be transversely spaced apart from each other based on a transverse width direction of the door body. Accordingly, the second guide 315 may guide the extension direction of the door wire W2 in a direction far away from the window.

The first guide 314 may have a structure of a pair of facing cantilevers. A first guide hole 314a surrounding the door wire W2 may be formed between the pair of cantilevers. As another example, the first guide 314 may have a single hook structure. In the embodiment, the first guide 314 is integrated with the base body 311. As another example, the first guide 314 may be formed into a separate object from the base body 311 and then fixed to the base body 311.

The second guide 315 may protrude roughly into a “U” shape. A second guide hole 315a surrounding the door wire W2 may be formed in the second guide 315. As another example, the second guide 315 may have a structure of a pair of cantilevers like the first guide 314. In the embodiment, the second guide 315 is integrated with the base body 311. As another example, the second guide 315 may be formed into a separate object from the base body 311 and then fixed to the base body 311. The structure of the wire guide 313 will be described again with a wire fixation part 354 described below.

Herein, a wire insertion port (not assigned with reference numeral) into which the door wire W2 is inserted may be provided at one side portion of the second guide 315. The wire insertion port may be open in a direction toward the edge of the door body. Accordingly, the door wire W2 inserted into the wire insertion port may be separated only in the edge direction of the door body, and not be separated in a direction toward the window V.

A seating surface 321 may be formed on a surface of the mounting station 320. The seating surface 321 may be a surface on which the movement supporter 350 slides on the surface of the mounting station 320. Since the mounting station 320 is a protruding portion of the base body 311, the seating surface 321 may be formed higher than other portions of the base body 311.

The seating surface 321 can include the supporter guide groove 323. The supporter guide groove 323 can be recessed from the seating surface 321. The supporter guide groove 323 can guide sliding of the movement supporter 350. The guide block 365a of the movement supporter 350 (referring to FIG. 11) can be inserted into the supporter guide groove 323 and the guide block 365a will be described below. While the guide block 365a is inserted into the supporter guide groove 323, the movement supporter 350 can be moved. Therefore, the supporter guide groove 323 can guide the movement of the movement supporter 350 in a constant direction. As another example, the supporter guide groove 323 may be omitted.

Referring to FIG. 10, a part of the first end portion of the supporter guide groove 323 can be open. The first end portion of the supporter guide groove 323 can be open toward the lower portion of the mounting base 310, i.e., toward the connector inlet 73a. Using the empty space of the open portion, the operation lever 365 of the movement supporter 350 described below can be turned.

The second end of the supporter guide groove 323 can include the mounting stopper 323a of a step structure. A part of the movement supporter 350 can interfere with the mounting stopper 323a. The mounting stopper 323a can be formed by a step difference between the recessed portion of the supporter guide groove 323 and the seating surface 321 which are different in height. A part of the movement supporter 350 can directly interfere with the mounting stopper 323a. In some examples, the movement supporter 350 can interfere with another portion of the mounting base 310.

The supporter guide groove 323 can include the storage fixation portion 327, 357. The storage fixation portion 327, 357 interfere with the movement supporter 350 to fix the movement supporter 350 and the connector assembly C to the storage position. When the movement supporter 350 and the connector assembly C are fixed to the storage position by the storage fixation portion 327, 357, the movement supporter 350 and the connector assembly C are not returned to the operation position, and remain fixed to the connector storage portion CM.

The storage fixation portion 327, 357 can be disposed in the movement direction of the door connector 370 continuously or discontinuously. When the storage fixation portion 327, 357 is provided in the movement direction of the door connector 370 continuously, the movement supporter 350 and the connector assembly C can be fixed to a plurality of storage positions in phases. When the storage fixation portion 327, 357 is moved provided in the movement direction of the door connector 370 discontinuously, the movement supporter 350 and the connector assembly C can be fixed to a limited storage position.

The storage fixation portion 327, 357 can include the first position fixation portion (or part) 327 and the second position fixation portion (or part) 357. The mounting base 310 of the connector module 300 can include the first position fixation portion 327. The second position fixation portion 357 can be provided in the movement supporter 350 or the door connector 370. The second position fixation portion 357 can be engaged with the first position fixation portion 327. When the second position fixation portion 357 is engaged with the first position fixation portion 327, the second position fixation portion 357 can remain caught by and fixed to the first position fixation portion 327.

Referring to FIG. 10, the first position fixation portion 327 can be provided on the surface of the supporter guide groove 323. The first position fixation portion 327 can be provided on a bottom surface of the recessed supporter guide groove 323. The first position fixation portion 327 can extend in the movement direction of the movement supporter 350. The first position fixation portion 327 can be continuously provided in the longitudinal direction of the supporter guide groove 323.

The first position fixation portion 327 can have an uneven structure. The first position fixation portion 327 can be configured by repeatedly arranging the structure recessed in the recessed direction of the supporter guide groove 323 and the protruding structure in the opposite direction. For example, the first position fixation portion 327 can have a sawtooth structure. The first position fixation portion 327 can have a sawtooth structure in which the height is gradually lowered toward the lower end of the mounting base 310. Then, the first position fixation portion 327 can catch the second position fixation portion 357 so that the movement supporter 350 is not moved in the direction toward the lower end of the mounting base 310 (downward based on the drawing).

The guide fence 312 can include the assembly piece 325. The assembly piece 325 can have a shape formed by cutting off a portion of the guide fence 312. The assembly piece 325 can enable the movement supporter 350 to be assembled and separated only at a specific position when being assembled to or separated from the mounting base 310.

The assembly piece 325 can be provided on the guide fence 312 into a kind of cantilever structure. The assembly piece 325 can be elastically deformed in the direction spreading from the guide fence 312 in the process in which the movement supporter 350 is seated on the seating surface 321. When the movement supporter 350 is seated on the seating surface 321, the assembly piece 325 can be recovered to the original form to prevent separation of the movement supporter 350.

The assembly piece 325 can include an assembly protrusion 325a. The assembly protrusion 325a can interfere with the movement supporter 350 when the movement supporter 350 is assembled. The assembly protrusion 325a can be formed such that the wide is gradually widened toward the seating surface 321. Accordingly, in the process of mounting the movement supporter 350, the assembly protrusion 325a can interfere with the movement supporter 350 to enable the entire assembly piece 325 to be naturally elastically deformed. More specifically, the assembly protrusion 325a can interfere with a portion of the assembly wing 352 of the movement supporter 350.

The assembly piece 325 can be disposed adjacent to the guide step 312a. The assembly wing 352 inserted into the assembly piece 325 can be moved below the guide step 312a. When the movement supporter 350 is moved, the assembly wing 352 can be moved along the guide step 312a.

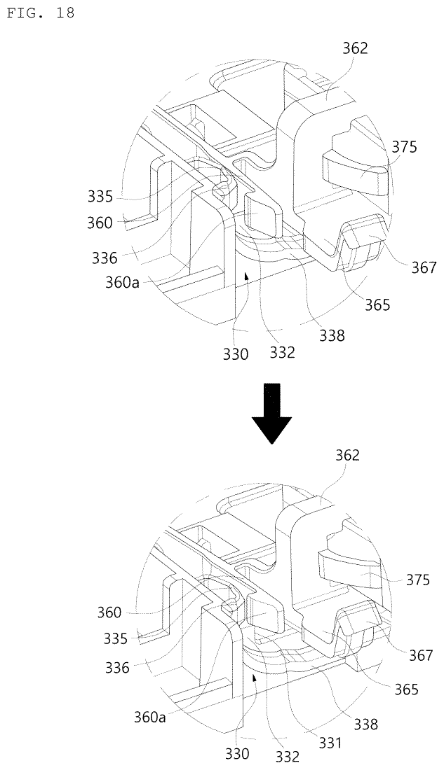

The lower end of the mounting base 310 may include a cover fixation part 329a, 329b. The cover fixation part 329a, 329b may fix a mounting cover 380 (referring to FIG. 19). The cover fixation part 329a, 329b may include a first cover fixation part 329a and a second cover fixation part 329b. The first cover fixation part 329a and the second cover fixation part 329b may be respectively provided on both portions of the lower end of the mounting base 310. The first end of the mounting cover 380 may be caught by the first cover fixation part 329a. The second end of the mounting cover 380 may be caught by the second cover fixation part 329b. The mounting cover 380 is turned with the first end caught by the first position fixation part 327, and the second end thereof may be assembled to the second cover fixation part 329b.

The mounting base 310 may include the restraint maintaining part 330. The restraint maintaining part 330 may fix the movement supporter 350 into the locked state when the movement supporter 350 is moved to the operation position. When a restraint head 360a of the movement supporter 350 is caught by a locking surface 332 of the restraint maintaining part 330, movement of the movement supporter 350 may be limited. The structure in which the restraint head 360a is restricted to and released from the restraint maintaining part 330 will be described below again.

The movement supporter 350 can be disposed in the mounting base 310. The door connector 370 can be mounted to the movement supporter 350. The door connector 370 can be moved along the mounting station 320 with the movement supporter 350. The movement supporter 350 can be moved between the storage position and the operation position. The movement supporter 350 can remain fixed to each of the storage position and the operation position.

A frame of the movement supporter 350 can be formed of the supporter body 351. The supporter body 351 can have a flat plate structure. The first surface of the supporter body 351 can be the supporting board 353 on which the door connector 370 is seated. The second surface of the supporter body 351 can be brought into close contact with the seating surface 321 of the mounting base 310. The entire length of the supporter body 351 (a vertical length based on the drawing) can be shorter than or equal to the length of the mounting station 320.

The supporter body 351 can include the assembly wing 352. The assembly wing 352 can protrude from an edge of the supporter body 351. The assembly wing 352 can protrude in the direction of widening the width of the supporter body 351. The assembly wing 352 can be symmetrically provided at either portion of the supporter body 351.

The assembly wing 352 can be assembled to the mounting base 310 while elastically deforming the assembly piece 325. The assembly wing 352 can be disposed below the guide step 312a adjacent to the assembly piece 325. The assembly wing 352 inserted into the assembly piece 325 can be moved below the guide step 312a. When the movement supporter 350 is moved, the assembly wing 352 can be moved along the guide step 312a.

The supporter body 351 may include the wire fixation part 354. The wire fixation part 354 may guide a direction in which the door wire W2 connected to the door connector 370 extends. The wire fixation part 354 may have a kind of clip structure. The wire fixation part 354 may have a clip structure to fix the door wire W2 while covering both side portions thereof. A wire fixation hole is open in a central portion of the wire fixation part 354, so the door wire W2 may pass through the wire fixation hole.

The movement supporter 350 can include the connector holder 362. The connector holder 362 can fix the door connector 370 to the movement supporter 350. The connector holder 362 can be provided below the supporting board 353. The connector holder 362 can have roughly a kind of rectangular frame structure surrounding a surface of the door connector 370. The mounting hole 364 can be provided in a central portion of the connector holder 362, and the door connector 370 can be disposed in the mounting hole 364.

The connector holder 362 can include a connector support end 363. The connector support end 363 can make the mounting hole 364 with the connector holder 362. The connector support end 363 can be disposed below the guide block 353a. When the connector holder 362 surrounds a first surface and both side surfaces of the door connector 370, the connector support end 263 can support a second surface of the door connector 370.

The movement supporter 350 can include the operation lever 365. The operation lever 365 can turn the movement supporter 350 into the locked state. The operation lever 365 can turn the movement supporter 350 into the released state. The operation lever 365 can extend from one end of the connector holder 362.

When the operator lifts the operation lever 365, the entire movement supporter 350 can be turned. When the movement supporter 350 is turned, the supporter restraint arm 360 of the movement supporter 350 can be released from the state of being caught by the restraint maintaining part 330 of the mounting base 310

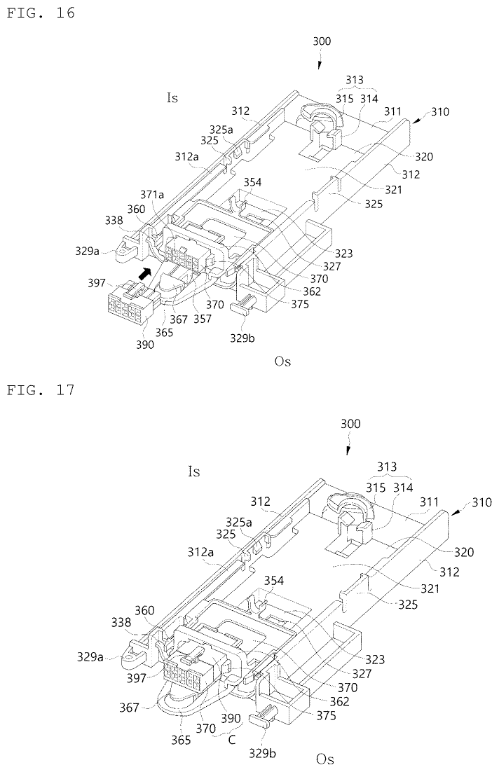

FIG. 18 illustrates the supporter restraint arm 360 changed from a locked state where it is restricted to the restraint maintaining part 330 to a released state where restriction is removed. As illustrated in the drawing, the restraint maintaining part 330 may be provided on the lower end of the mounting base 310. The restraint maintaining part 330 may include a locking step 331 and a releasing step 335. When the restraint head 360a of the supporter restraint arm 360 is caught by the locking step 331, the movement supporter 350 may be in the locked state. When the restraint head 360a is caught by the releasing step 335, the movement supporter 350 may be in the released state. In a lower part of FIG. 18, the supporter restraint arm 360 is lifted, and the locking step 331 is exposed.

More specifically, the locking step 331 may be disposed below the releasing step 335. The locking step 331 may include a locking surface 332. The locking surface 332 may include a flat surface structure toward the connector inlet 73a. The restraint head 360a is fixed by being substantially caught by the locking surface 332.

The releasing step 335 may be provided above the locking step 331. When the supporter restraint arm 360 is raised, the restraint head 360a faces the releasing step 335. The releasing step 335 may be formed with a width gradually widened in the second direction toward the operation position.

The releasing step 335 may include a releasing surface 336 having an inclined surface or a curved surface. The releasing surface 336 may be formed in a direction of widening the width of the lower end of the mounting base 310. Accordingly, the restraint head 360a may be guided by the releasing surface 336. In this process, the supporter restraint arm 360 may be elastically deformed in a shape closed in a direction toward a side surface of the movement supporter 350.

The restraint maintaining part 330 may include an assembly guide 338. The assembly guide 338 may protrude from a lower end surface of the restraint maintaining part 330. The assembly guide 338 may be formed in a rib shape on the lower end surface of the restraint maintaining part 330. In the embodiment, an end portion 339 of the assembly guide 338 may have a shape partially surrounding the locking surface 332 and the releasing surface 336 and may be formed into a curved path. The assembly guide 338 may have a shape corresponding to the shape of the connector inlet 73a.

The upper view in FIG. 18 illustrates the restraint head 360a caught by the locking surface 332 of the locking step 331. In this state, the restraint head 360a and the locking surface 332 are brought into surface contact with each other, so that the movement of the restraint head 360a may be limited as the restraint head 360a is caught by the locking surface 332. To remove the locked state, the fixation end portion 357a should be separated from the locking surface 332.

The releasing step 335 may have a transverse width smaller than the locking step 331. Accordingly, a releasing space 337, i.e., a kind of empty space, may be provided between the locking step 331 and the releasing step 335. When the restraint head 360a is located in the releasing space 337, releasing of the movement supporter 350 may start.

To this end, the fabricator can lift the operation lever 365. When the fabricator lifts the operation lever 365, the entire movement supporter 350 may be turned. When the movement supporter 350 is turned, the supporter restraint arm 360 may also turned.

This state is illustrated in the lower part of FIG. 18. The lower view in FIG. 18 illustrates the restraint head 360a facing the releasing surface 336. When the supporter restraint arm 360 is lifted upward based on FIG. 18, the restraint head 360a may face the releasing surface 336. Herein, the restraint head 360a and the releasing surface 336 are not in surface-contact with each other, and the curved surface or the inclined surface of the releasing surface 336 and the restraint head 360a may be brought into linear-contact with each other. Therefore, the restraint head 360a may be guided along the releasing surface 336, and the supporter restraint arm 360 may be elastically deformed in a direction closed inward. As described above, when the restraint head 360a is moved to the releasing position, the locked state occurring by the restraint maintaining part 330 may be removed. The movement supporter 350 and the connector assembly C may be moved to the storage position.

Meanwhile, referring to FIG. 10, in some examples, the operation lever 365 can have roughly a “U” shape. A central portion of the operation lever 365 can be formed by being penetrated, and the second position fixation portion 357 can be provided in the penetrated portion. The second position fixation portion 357 can be fixed by being caught by the first position fixation portion 327. The second position fixation portion 357 can have a kind of hook structure. The second position fixation portion 357 of a hook structure can be fixed by being caught by the first position fixation portion 327 of a sawtooth shape. In FIG. 10, reference numerals 377 and 397 represent assembly parts for assembling two connectors, respectively.

As illustrated in FIG. 11, the operation lever 365 can include the guide block 365a. While the guide block 365a is located in the supporter guide groove 323, the movement supporter 350 can be linearly moved. The guide block 365a can be provided at a portion where the operation lever 365 and the supporting board 353 are connected to each other.

The guide block 365a can have a lower height than the supporting board 353. A step difference surface between the guide block 365a and the supporting board 353 can be caught by the mounting stopper 323a, i.e., a step structure at a second end portion of the supporter guide groove 323. When the guide block 365a is caught by the mounting stopper 323a, the movement range of the movement supporter 350 can be limited.

Referring to FIG. 12, the operation lever 365 can include a connection bridge 366. The connection bridge 366 can connect the operation lever 365 to a release lever 367. The release lever 367 can separate the second position fixation portion 357 from the first position fixation portion 327 while being turned. For reference, FIG. 12 illustrates the release lever 367 pushed to raise the second position fixation portion 357. Then, the second position fixation portion 357 can be separated from being caught by the first position fixation portion 327.

On the connection bridge 366 as the center, the second position fixation portion 357 can be provided at a first end, and the release lever 367 can be provided at a second end. Accordingly, when the release lever 367 is pushed or raised on the connection bridge 366 as the center, the second position fixation portion 357 can be raised or pushed on the contrary. In other words, the operation part can have a kind of lever structure. Herein, the connection bridge 366 can be a supporting point, and the release lever 367 can be a target point.

Describing the catching structure between the first position fixation portion 327 and the second position fixation portion 357, first, FIG. 11 illustrates the movement supporter 350 and the connector assembly C disposed in the storage position. Herein, the second position fixation portion 357 of the movement supporter 350 can be engaged with the first position fixation portion 327 to be fixed to the storage position. To release the fixed state, the release lever 367 should be pushed, and FIG. 11 illustrates the release lever 367 in a pushed state. When the operator pushes the release lever 367, the second position fixation portion 357 at the opposite side of the release lever 367 based on the connection bridge 366 can be raised.

In this state, when the movement supporter 350 is pulled downward (leftward based on the drawings), the movement supporter 350 and the connector assembly C disposed at the movement supporter 350 can be moved together. Herein, when the movement supporter 350 is pulled with the release lever 367 remaining pushed, the second position fixation portion 357 does not interfere with the first position fixation portion 327 and can be moved.

FIG. 12 illustrates the movement supporter 350 and the connector assembly C moved along the supporter guide groove 323 to be disposed at the lower portion of the mounting base 310. In other words, the movement supporter 350 and the connector assembly C are moved to the operation position. When the movement supporter 350 and the connector assembly C are moved to the operation position, the operator can remove a force pushing the release lever 367. Then, with the connection bridge 366 as the center, the release lever 367 can be recovered upward, and the second position fixation portion 357 at the opposite side can be moved downward. The above state is illustrated in FIG. 13.

Herein, the movement supporter 350 and the connector assembly C can be in the locked state at the operation position. The supporter restraint arm 360 of the movement supporter 350 can be fixed to the restraint maintaining part 330 of the mounting base 310 to be in the locked state. The second position fixation portion 357 can be engaged with the first position fixation portion 327 of the lowermost end (a leftmost side based on the drawing) of the first position fixation portion 327.

On the contrary, to move the movement supporter 350 and the connector assembly C to the storage position, the operator should lift the operation lever 365. When the operation lever 365 is raised, the state in which the restraint head 360a of the supporter restraint arm 360 of the movement supporter 350 is caught by the restraint maintaining part 330 of the mounting base 310 is released. In this state, when the movement supporter 350 is pushed, the movement supporter 350 and the connector assembly C can be moved to the storage position.

Herein, there is no need to push the release lever 367. When the movement supporter 350 is moved rightward based on FIG. 57, the second position fixation portion 357 can pass over inclination of the first position fixation portion 327, so there is no need to push the release lever 367. In the process in which the second position fixation portion 357 passes over the first position fixation portion 327, the release lever 367 can be repeatedly raised and then recovered to the original form by using an elastic force of the connection bridge 366.

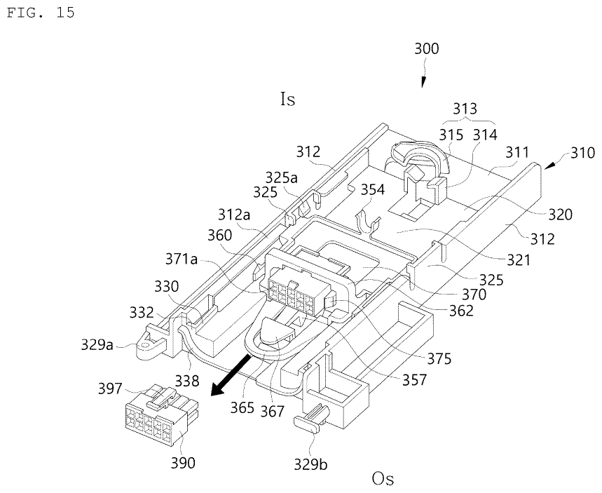

FIGS. 14 to 17 illustrate assembly of the connector module 300 of an example of a movement of the movement supporter 350, and the assembly process between the movement supporter and the relative connector 390 in order. FIG. 14 illustrates the movement supporter 350 and the door connector 370 spaced apart from the mounting base 310. The door connector 370 can be mounted to the connector holder 362 of the movement supporter 350. The connector lance part 375 of the door connector 370 can pass through the mounting hole 264 provided in the movement supporter 350 and can be fixed by being caught by the opposite side of the mounting hole 264.

In this state, the movement supporter 350 and the door connector 370 can be seated on the mounting station 320 of the mounting base 310. When the movement supporter 350 and the door connector 370 are moved in the direction toward the mounting station 320 (a direction of arrow \textcircled{1}, the assembly wing 352 of the movement supporter 350 can interfere with the assembly protrusion 325a of the assembly piece 325. In the interference process, the assembly wing 352 can elastically deform the assembly piece 325 in a direction spreading from the mounting station 320 (a direction of arrow \textcircled{2}).

As illustrated in FIG. 15, when the assembly wing 352 is moved below the assembly protrusion 325a, the assembly piece 325 can be recovered to the original form. At the same time, the guide block 365a of the movement supporter 350 can be inserted into the supporter guide groove 323. The guide block 365a is disposed on a lower surface of the movement supporter 350, so the guide block 365a is invisible due to the angle in FIG. 15.

When the movement supporter 350 and the door connector 370 are assembled as described above, the movement supporter 350 and the door connector 370 are disposed in the storage position. In this state, the movement supporter 350 can be moved in the arrow direction of FIG. 15. In other words, the movement supporter 350 and the door connector 370 are moved to the operation position.

At this point, since the second position fixation portion 357 is caught by the first position fixation portion 327, the operator should push the release lever 367 first in order to move the movement supporter 350. Referring to FIG. 11, when the release lever 367 is pushed, the second position fixation portion 357 is separated from the first position fixation portion 327 and released from the locked state.

In this state, when the movement supporter 350 is pulled in the arrow direction of FIG. 15, the movement supporter 350 can be moved the operation position. The movement supporter 350 moved to the operation position can be fixed at the operation position by being caught by the restraint maintaining part 330. In other words, the movement supporter 350 and the door connector 370 are in the locked state. The figure as described above is illustrated in FIG. 16.

Next, the relative connector 390 can be assembled to the door connector 370. Since the assembly surface 371a of the door connector 370 faces the relative connector 390 in the locked state, the relative connector 390 can be easily assembled to the door connector 370. The arrow of FIG. 16 indicates an assembly direction of the relative connector 390.

The door connector 370 fixed to the restraint maintaining part 330 can be prevented from being pushed rearward, i.e., toward the storage position when being assembled with the relative connector 390. Accordingly, the operator can easily assemble the connector assembly C. Specifically, since the door connector 370 is fixed in a specific direction, the operator does not need to reconfirm the directionality of the door connector 370. FIG. 17 illustrates the completed assembly of the connector assembly C.

Meanwhile, the connector inlet 73a may include a mounting cover 380. Referring to FIG. 19, the mounting cover 380 may block the connector inlet 73a, thereby covering the connector assembly C. More specifically, the mounting cover 380 may allow the pass of the main wire W1 extending from the relative connector 390, and cover the lower portion of the relative connector 390. When the mounting cover 380 is removed in FIG. 19, a lower part of the relative connector 390 may be exposed.

Referring to FIG. 7, the door wire W may be partially bent by being pushed toward the image acquisition module 100 (upward direction based on the drawing). Herein, a part of the door wire W2 between the first guide 314 and the second guide 315 may be referred to as the first portion W2a, and a part of the door wire W2 that passes through the second guide 315 may be referred to as a second portion W2b.

When the door wire W is pushed toward the image acquisition module 100 (upward direction based on the drawing), a part that passes through the second portion W2b may be naturally bent, and the portion may be referred to as a third portion W2c. The extension direction of the door wire W to the second portion W2b may be fixed by the second guide 315. The second guide 315 may induce the second portion W2b in a direction far away from the window V, i.e., toward the edge of the door body. Therefore, even when the third portion W2c is bent, the door wire does not cross the window V.

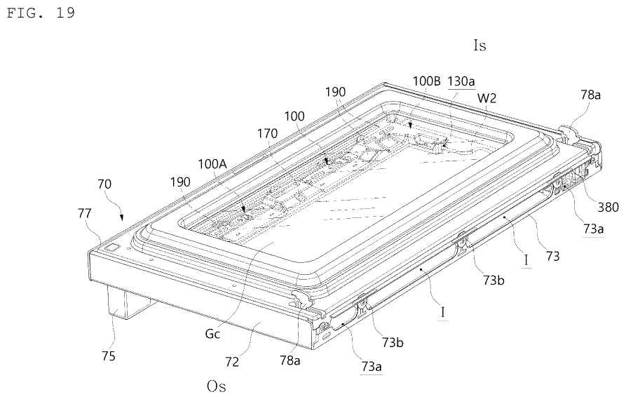

FIG. 20 illustrates an example of a connector module 700 constituting the door for a home appliance according to the present disclosure. The structure overlapped with the above-described example is assigned with the same reference numeral in the 700's, and a detailed description will be omitted.

The connector storage portion CM can be provided in the lower door 70. The connector storage portion CM can be provided in the door body in the lower door 70. The connector storage portion CM can be provided in the front frame part 72 constituting a frame of the door body. The front side plates 72a, i.e., a part of the front frame part 72, can define both side surfaces of the door body. As described above, the connector storage portion CM can be provided in a front side plate 72a constituting both side surfaces of the door body.

As illustrated in FIG. 20, the connector module 700 can stand in the connector storage portion CM. The connector module 700 may not be seated on the front panel Ga, and can be disposed in the connector storage portion CM provided in the front side plate 72a. A transverse width of the connector module 700 can be formed equal to or smaller than the width of each front side plate 72a. Since the connector storage portion CM is provided at the lower end of the front frame part 72, the operator can easily access the connector module 700 through the connector inlet 73a of the lower door 70.

Herein, each front side plate 72a has roughly a concavely “C” shape, and the connector storage portion CM can be provided in the concave portion. The connector storage portion CM can be integrally formed with the front side plate 72a. Accordingly, the door connector 770 can be linearly moved along the concave portion of the front side plate 72a.

Although not shown in the drawing, the movement supporter 750 may be moved transversely with respect to the mounting base 710. Based on FIG. 20, the movement supporter 750 may be moved in the transverse direction, i.e., the width direction of the lower door 70, not the vertical direction.

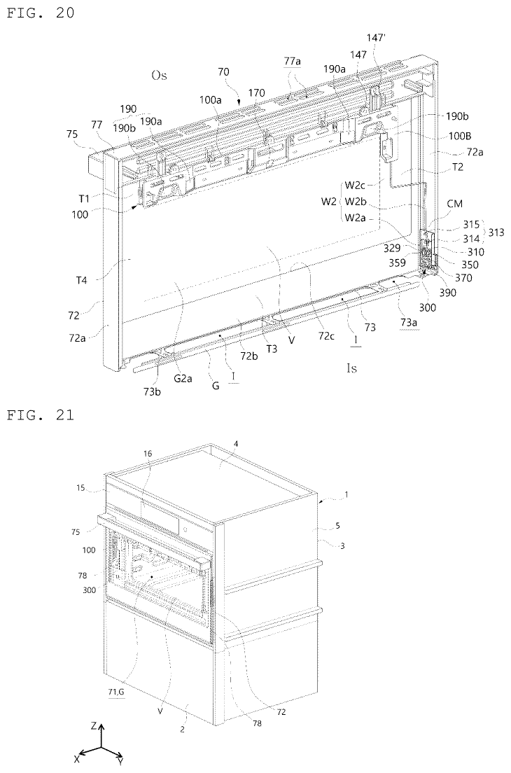

FIG. 21 illustrates another example of a home appliance according to the present disclosure. As illustrated in the drawing, the home appliance may be a built-in type of home appliance. For example, the home appliance may be a cooking appliance installed in a built-in manner. The cooking appliance of the embodiment may be installed in kitchen furniture 1, etc., and the front surface of the cooking appliance may only be exposed forward. A lower part, a rear surface 3, an upper surface 4, and a side surface 5 of the kitchen furniture 1 may shield portions of the home appliance excluding the operating part 15, the display 16, the door 70, etc. that are disposed at the front surface of the home appliance. The image acquisition module 100 and the connector module 300 which are described above may be disposed in the lower door 70.

In the embodiment, the window may be omitted in the door 70. The inside space of the cooking appliance is not visible through the door 70, and may be checked only by the image acquisition module 100. Since there is no need to worry about the image acquisition module 100 being exposed forward of the cooking appliance through the window, the image acquisition module 100 may be disposed in a central region in the door 70.

Although the preferred implementations of the present disclosure have been described for illustrative purposes, those skilled in the art will appreciate that various modifications, additions and substitutions are possible, without departing from the scope and spirit of the present disclosure as disclosed in the accompanying claims. Therefore, the preferred implementations described above have been described for illustrative purposes, and should not be intended to limit the technical spirit of the present disclosure, and the scope and spirit of the present disclosure are not limited to the implementations. The protective scope of the present disclosure should be interpreted by the accompanying claims, and all technical spirits within the equivalent scope should be interpreted as being included in the scope and spirit of the present disclosure.

What is claimed is:

1. A door for an appliance, the door comprising:
a door body configured to be disposed at a front of a storage space of the appliance, the door body accommodating an electronic component therein; and
a connector module disposed in the door body and electrically connected to the electronic component through a door wire,
wherein the connector module comprises:
a mounting base that is disposed inside the door body and defines a seating surface,
a movement supporter disposed at the seating surface of the mounting base and configured to move along the seating surface,
a door connector disposed at the movement supporter and configured to move along with the movement supporter, and
at least one storage fixation portion that is disposed at (i) the seating surface of the mounting base or (ii) a facing surface of the movement supporter that faces the seating surface, the at least one storage fixation portion being configured to restrict movement of the movement supporter relative to the mounting base.

2. The door of claim 1, wherein the at least one storage fixation portion comprises:
a first position fixation part disposed at the seating surface; and
a second position fixation part disposed at the facing surface of the movement supporter and configured to engage with the first position fixation part.

3. The door of claim 2, wherein the first position fixation part comprises an uneven structure arranged along a movement direction of the movement supporter, and
wherein the second position fixation part is configured to elastically deform and be caught by the first position fixation part.

4. The door of claim 2, wherein the second position fixation part comprises:
a connection bridge connected to the movement supporter;
a holding hook disposed at a first end portion of the connection bridge and configured to engage with the first position fixation part; and
a release lever disposed at a second end portion of the connection bridge and configured to elastically deform toward the seating surface of the mounting base,
wherein the connection bridge defines a movement center point between the holding hook and the release lever, and
wherein the holding hook and the release lever are configured to move in opposing directions with respect to the movement center point.

5. The door of claim 2, wherein the movement supporter is configured to move between a storage position and an operation position along the seating surface of the mounting base, and
wherein the first position fixation part comprises an inclined structure that is inclined toward the operation position.

6. The door of claim 2, wherein the first position fixation part comprises a plurality of sawtooth parts, and
wherein each of the plurality of sawtooth parts comprises:
a first vertical surface that extends in a direction in which the movement supporter is stacked on the seating surface; and
a first inclined surface that extends from the first vertical surface and is inclined with respect to a movement direction of the movement supporter.

7. The door of claim 6, wherein the second position fixation part comprises:
a second vertical surface configured to be caught by the first vertical surface and to be in contact with the first vertical surface; and
a second inclined surface that extends from the second vertical surface and configured to face the first inclined surface and to be guided by the first inclined surface.

8. The door of claim 2, wherein the mounting base defines a supporter guide groove that is recessed from the seating surface, and
wherein the first position fixation part is disposed in the supporter guide groove.

9. The door of claim 8, wherein the movement supporter comprises a guide block disposed in the supporter guide groove.

10. The door of claim 8, wherein the movement supporter is configured to move between a storage position and an operation position along the seating surface of the mounting base, and
wherein the supporter guide groove has:
a first end portion that is open toward the storage position; and
a second end portion that defines a mounting stopper that is stepped from the seating surface and configured to interfere with the mounting stopper based on the movement supporter moving relative to the mounting base.

11. The door of claim 1, wherein the mounting base comprises:
a guide fence that is disposed at least one lateral side of the mounting base and extends in a standing direction relative to the seating surface; and
a guide step that protrudes from the guide fence in a direction different from the standing direction of the guide fence, and
wherein a part of the movement supporter is disposed between the guide step and the seating surface.

12. The door of claim 11, wherein the guide fence comprises an assembly piece configured to be elastically deformed by the movement supporter in a direction away from a center portion of the seating surface, and
wherein the movement supporter is configured to interfere with the assembly piece based on being seated on the seating surface and elastically deforming the assembly piece.

13. The door of claim 12, wherein the mounting base further comprises an assembly protrusion that protrudes from the assembly piece and is configured to elastically deform the assembly piece based on interfering with a surface of the movement supporter.

14. The door of claim 13, wherein the movement supporter comprises an assembly wing that protrudes from a side surface of the movement supporter and is configured to be disposed below the guide step.

15. The door of claim 14, wherein the assembly wing is configured to interfere with the assembly protrusion.

16. The door of claim 1, wherein the movement supporter comprises a connector holder that covers at least a portion of the door connector and is configured to orient the door connector in a predetermined direction.

17. The door of claim 1, wherein the movement supporter is configured to move between a storage position and an operation position along the seating surface of the mounting base, and
wherein the mounting base comprises a restraint maintaining part configured to move relative to the seating surface, the restraint maintaining part being configured to restrict the movement supporter from moving from the operation position based on interfering with a part of the movement supporter at the operation position.

18. The door of claim 17, wherein the movement supporter comprises an operation lever that protrudes toward the operation position and is configured to turn the movement supporter in response to an external force applied to the operation lever to thereby separate a part of the movement supporter from the restraint maintaining part.

19. The door of claim 1, wherein the movement supporter comprises:
an operation lever;
a release lever disposed inside the operation lever and configured to release a fixed state of the movement supporter from the at least one storage fixation portion based on the release lever being pressed; and
a connection bridge that connects the release lever and the operation lever to each other.

20. An appliance comprising:
a main body that defines a storage space;
a door body that is disposed at a front of the storage space and accommodates an electronic component therein; and
a connector module disposed in the door body and electrically connected to the electronic component through a door wire,
wherein the connector module comprises:
a mounting base that is disposed inside the door body and defines a seating surface,
a movement supporter disposed at the seating surface of the mounting base and configured to move along the seating surface,
a door connector disposed at the movement supporter and configured to move along with the movement supporter, and
at least one storage fixation portion that is disposed at (i) the seating surface of the mounting base or (ii) a facing surface of the movement supporter that faces the seating surface, the at least one storage fixation portion being configured to restrict movement of the movement supporter relative to the mounting base.
